(19) United States
(12) Patent Application Publication
(10) Pub. No.: US 2024/0111286 A1
(43) Pub. Date: Apr. 4, 2024

(54) AUTONOMOUS CONTROL SYSTEM AND METHOD FOR VESSEL

(71) Applicant: Honda Motor Co., Ltd., Tokyo (JP)

(72) Inventors: Takashi HASHIZUME, Saitama (JP); Ryuichi KIMATA, Tokyo (JP); Ryota HISADA, Tokyo (JP); Koichi TSUNO, Saitama (JP)

(73) Assignee: Honda Motor Co., Ltd., Tokyo (JP)

(21) Appl. No.: 17/956,831

(22) Filed: Sep. 30, 2022

(51) Int. Cl. G05D 1/02; B63B 79/15; B63B 79/40; B63H 21/21; B64C 39/02; G05D 1/00

(52) U.S. Cl. CPC G05D 1/0206; B63B 79/15; B63B 79/40; B63H 21/21; B64C 39/024; G05D 1/0088; B64C 2201/122

(57) ABSTRACT

An autonomous control system and method for a vessel are provided. The autonomous control system includes a route setting unit, setting a route to a destination; a disturbance data acquisition unit, acquiring disturbance data from sources other than the vessel; an autonomous control unit, performing a control of the vessel based on the route set by the route setting unit and corrects the control of the vessel based on the disturbance data acquired by the disturbance data acquisition unit.

### BACKGROUND

### Technical Field

The disclosure relates to a ship control, and particularly to an autonomous control system and method for vessel

### Description of Related Art

For vessel, since the wind disturbance is large, the vessel is usually equipped with an anemometer or the like to detect or measure the wind speed and the wind speed, and the measured wind speed and wind speed are used for vessel control. However, since the wind flow is very complicated, the wind flow is different between the vessel's current position and its next position, the correction for compensating the wind disturbance is slow by using only the wind measurements at the current position of the vessel.

In the existent method, the vessel is equipped with anemometer to measure the wind direction and the wind speed, and the measured wind speed is reflected in the control of the vessel. However, such method cannot provide precise control.

Therefore, there are still needs to develop a solution to take the wind direction and the wind speed at various positions other than the own vessel into consideration.

### SUMMARY

In view of the above description, according to one embodiment of the disclosure, an autonomous control system for a vessel is provided. The autonomous control system comprises a route setting unit, setting a route to a destination; a disturbance data acquisition unit, acquiring disturbance data from sources other than the vessel; an autonomous control unit, performing a control of the vessel based on the route set by the route setting unit and corrects the control of the vessel based on the disturbance data acquired by the disturbance data acquisition unit.

According to one embodiment, in the autonomous control system, the disturbance data comprises disturbance information and data acquisition position information, and the autonomous control unit is further configured to correct the control of the vessel based on the disturbance data within a predetermined distance from the route.

According to one embodiment, in the autonomous control system, the disturbance data comprises at least one of a wind speed and direction and tide information.

According to one embodiment, in the autonomous control system, the sources comprise at least one of other vessels, anemometers arranged on a marina, an anemometer arranged on a trailer at a shore.

According to one embodiment, in the autonomous control system, the disturbance data is obtained from at least one of an aerial drone and an underwater drone capable of communicating with the vessel.

According to one embodiment, in the autonomous control system, the disturbance data is obtained from satellite images.

According to one embodiment, in the autonomous control system, when a drafting direction of the vessel due to disturbance is specified, the vessel is applied by a propulsion in a direction opposite to the drafting direction to keep the vessel move along the route.

According to one embodiment, in the autonomous control system, the disturbance data has plural types.

According to one embodiment, in the autonomous control system, the autonomous control unit has an automatic berthing mode, and an automatic berthing control is temporally stopped when the disturbance data is equal to or larger than a predetermined value.

According to one embodiment, in the autonomous control system, the automatic berthing control is in operation, the disturbance data is received from other vessels and disturbance data collection devices arranged on a marina or trailers.

According to another embodiment of the disclosure, an autonomous control method for a vessel is provided. The autonomous control method for a vessel, comprising: setting a route to a destination; acquiring disturbance data from sources other than the vessel; and performing a control of the vessel based on the set route and corrects the control of the vessel based on the acquired disturbance data.

According to one embodiment, in the autonomous control method, the disturbance data comprises disturbance information and data acquisition position information, and the method further comprises: correcting the control of the vessel based on the disturbance data within a predetermined distance from the route.

According to one embodiment, in the autonomous control method, the disturbance data comprises at least one of a wind speed and direction and tide information.

According to one embodiment, in the autonomous control method, the sources comprise at least one of other vessels, anemometers arranged on a marina, an anemometer arranged on a trailer at a shore.

According to one embodiment, in the autonomous control method, the method further comprises obtaining the disturbance data from at least one of an aerial drone and an underwater drone capable of communicating with the vessel.

According to one embodiment, in the autonomous control method, the method further comprises obtaining the disturbance data from satellite images.

According to one embodiment, in the autonomous control method, the method further comprises specifying a drafting direction of the vessel due to disturbance; and applying a propulsion to the vessel in a direction opposite to the drafting direction to keep the vessel move along the route.

According to one embodiment, in the autonomous control method, the disturbance data has plural types.

According to one embodiment, in the autonomous control method, in a case that an automatic berthing mode is performed, the method further comprises: temporally stopping an automatic berthing control when the disturbance data is equal to or larger than a predetermined value.

According to one embodiment, in the autonomous control method, the automatic berthing control is in operation, and the method further comprises: receiving the disturbance data from other vessels and disturbance data collection devices arranged on a marina or trailer.

According to the above embodiments, by installing an anemometer at the berthing position (such as the pier or trailer located at the shore), the wind direction and the wind speed at various positions other than the own vessel may be received by the own vessel. In addition, the disturbance data closest to the route of the vessel may be used to correct the vessel control, and thus the precision of the vessel control may be increased.

### BRIEF DESCRIPTION OF THE DRAWINGS

FIG. 1 illustrates a concept diagram of the autonomous control system according to one embodiment of the disclosure.

FIG. 2 illustrates an operation diagram of the autonomous control system according to one embodiment of the disclosure.

FIG. 3 illustrates a block diagram of an autonomous control system according to one embodiment of the disclosure.

FIG. 4 illustrates a flow chart of an autonomous control method according to one embodiment of the disclosure.

### DESCRIPTION OF THE EMBODIMENTS

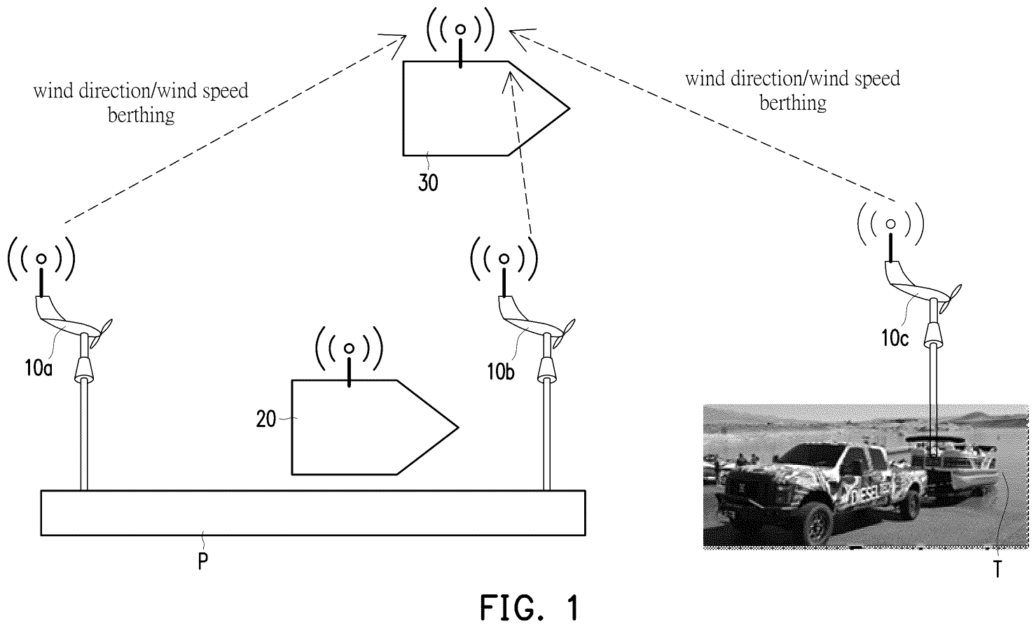

FIG. 1 illustrates a concept diagram of the autonomous control system according to one embodiment of the disclosure. In the embodiment, an automatic berthing control is used as an example of the autonomous control, which is not used to limit the scope of the disclosure.

In FIG. 1, a pier P is illustrated as an example of a berthing position (destination of the vessel 20) in the automatic berthing control. When the vessel 20 moves to the berthing position along the berthing route indicated by the arrow during the automatic berthing control, the berthing may be affected by external disturbance, such as the wind, the tide or wave of the sea, or the wake of an another vessel. In addition to the pier, the vessel 20 moves to dock to a quay or marina may be also a scenario of the disclosure.

The wind field in the vicinity of the berthing position is very complicated. Therefore, according to the embodiment of the disclosure, a plurality of anemometers 10a, 10b, 10c is provided for measuring the wind direction and wind speed at various location. anemometers 10a, 10b, 10c may be referred as disturbance data collection devices.

For example, the anemometer 10a can be arranged on a roof of the pier P (or a marina, quay), another anemometer 10b can be arranged at another location of the pier P. In addition, the anemometer 10c may be arranged on a trailer T. The trailer T may be docked at any location, such as on the shore. By these anemometers 10a, 10b and 10c, the disturbance data related to the wind direction and wind speed at different locations on the pier P and/or one the shore may be measured. In one embodiment, the disturbance data comprises disturbance information and data acquisition position information. For example, the disturbance information may be wind direction/wind speed, tide information, etc., and the acquisition position information represents the position where the disturbance information is measured or obtained.

Then, the measured wind direction and wind speed at different locations may be transmitted to the vessel 20 that is in the automatic berthing control. During the automatic berthing control, the vessel 20 can continuously receives the disturbance data related to the wind direction and wind speed at different locations on the pier P and/or one the shore. The vessel 20 will uses the disturbance data of the wind direction and wind speed measured by an anemometer that is closest the vessel 20. Here, the anemometer is a kind of source that provides the disturbance data. In this way, by providing a plurality of anemometers on the pier P and/or on the shore, the disturbance data due to the wind direction and wind speed can be used to the external disturbance control according to the berthing position. Namely, during the automatic berthing control, the vessel 20 may be affected (such drafted) due to the wind field, and the drafted route can be compensated by the disturbance data received from the plurality of anemometers 10a, 10b, 10c.

In addition to the disturbance data obtained from the anemometers on the pier P and/or the trailer T, the vessel 20 may also acquire other disturbance data from the another vessel.

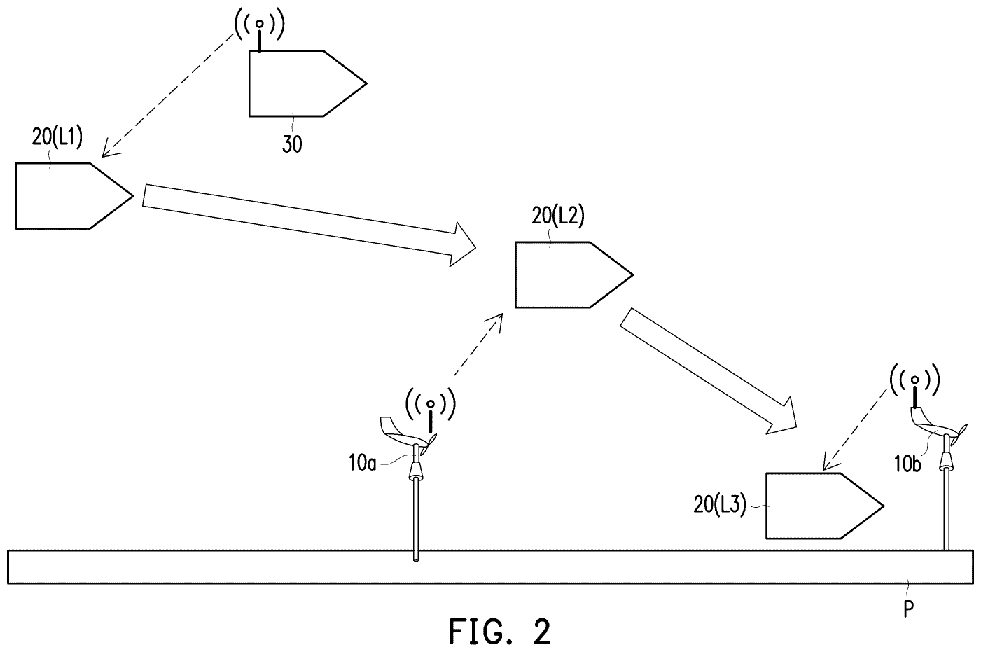

FIG. 2 illustrates an operation diagram of the autonomous control system according to one embodiment of the disclosure. In FIG. 2, the vessel 20 can obtain the disturbance data from the anemometers 10a, 10b on the pier P and the another vessel 30.

When the vessel 30 performs the automatic berthing control to berth the vessel to the berthing position, the vessel 20 movers from the position L1 to the position L3 along a berthing route indicated by the arrow. In FIG. 2, the vessel 20 can continuously obtain the disturbance data related to the wind direction and wind speed at different locations from the anemometers 10a, 10b on the pier P and the another vessel 30. Also, though not shown in FIG. 2, as described in FIG. 1, another anemometer 10c may be provided on the trailer T.

During the automatic berthing control of the vessel 20, the vessel 20 moves along the berthing route from the location L1, through the location L2, and to the location L3 where is almost the berthing position. As described above, the vessel 20 continuously obtains the disturbance data related to the wind direction and wind speed at different locations L1˜L3 from the anemometers 10a, 10b on the pier P and from the another vessel 30. During the automatic berthing control, the vessel 20 will use the disturbance data related to the wind direction and wind speed that is closest to the vessel or in the moving direction.

For example, when the vessel 20 is at the location L1, the vessel uses the disturbance data obtained from the another vessel 30 that is closest to the vessel and/or for example the disturbance data obtained from the anemometer 10a on the pier where the vessel 20 heads to. When the vessel 20 is at the location L2, the vessel uses the disturbance data obtained from the anemometer 10a on the pier that is closest to the vessel 20 and/or the disturbance data obtained from the anemometers 10b on the pier where the vessel 20 heads to. When the vessel 20 is at the location L3, the vessel uses the disturbance data obtained from the anemometer 10b on the pier where the vessel 20 that is closest to the vessel 20. At this time, the vessel 20 is very close to the berthing position.

According to the embodiment, since the disturbance data related to the wind direction and wind speed can be obtained from other vessel and/or from a plurality of anemometers arranged on the pier or the trailer, even though the wind field is very complicated during the vessel berths to the berthing position, the vessel can use the disturbance data that is closest to the vessel and thus the berthing route can be compensated when the vessel is affected by the disturbance of wind field.

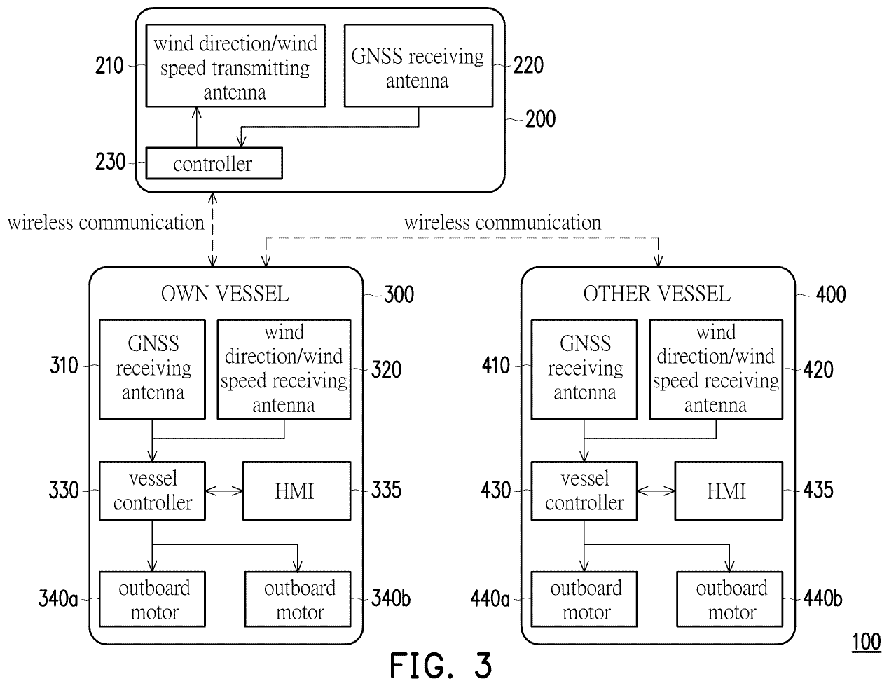

FIG. 3 illustrates a block diagram of an autonomous control system according to one embodiment of the disclosure. In FIG. 3, the autonomous control system 100 comprises at least one anemometer 200, a vessel 300 and at least one another vessel 400. The anemometer 200 is used to measure a wind direction and a wind speed, and may be provided on the pier, marina, or quay. In addition, the anemometer 200 may be provided on a trailer docked on the shore.

In the following description, a boat with outboard motors as power driving the boat is used as an example of the vessel 300. In the following embodiment, the vessel 200 is powered by two outboard motors 340a and 340b. In other embodiment, one or more than two outboard motors may be equipped and the number of the equipped outboard motors is not particularly limited.

The anemometer 200 comprises a wind direction and speed transmitting antenna 210, a GNSS receiving antenna 220 and a controller 230. The anemometer 200 is used to measure the wind speed and the wind direction at the installation location of the anemometer 200.

The wind direction and wind speed transmitting antenna 210 is used to transmit data of the wind direction and the wind speed to the vessel 300 and the other vessels 400. The anemometer 200 may continuously measure the wind direction and the wind speed at the location where the anemometer 200 is disposed. Also, the measured wind direction and the wind speed may constantly provide to the vessel 300 and the other vessels 400 by the wind direction and wind speed transmitting antenna 210.

The GNSS receiving antenna 220 is used to receive the GNSS signals. The GNSS (global navigation satellite system) is a system that uses satellites to provide autonomous geo-spatial positioning. The GNSS allows satellite navigation devices (the may be provided in the anemometer 200, the vessel 300 and the another vessel 400) to determine the position (longitude, latitude, and altitude/elevation) with high precision using time signals transmitted along a line of sight by radio from satellites. The system can be used for providing position, navigation or for tracking the position of something fitted with a receiver (satellite tracking).

With the GNSS receiving antenna 220, signals from the satellite may be received and the position of the anemometer 200 may be determined.

The controller 230 may control the all operations of the anemometer 200 and the wind direction and wind speed transmitting antenna 210, and the GNSS receiving antenna 220. The other components required for the operations of the anemometer 200 may be also controlled by the controller 230. In addition, although not shown in FIG. 3, the anemometer 200 may further comprise a wireless communication unit or interface that is able to communicate with the vessel 200 and the other vessels 300, such as data or command transmission and reception.

The autonomous control system of the vessel 300 comprises a GNSS receiving antenna 310, a wind direction and speed receiving antenna 320, a vessel controller (autonomous control unit) 330, a route setting unit, and other components (not shown) for operations of the vessel 300. The route setting unit is configured to set a route of the vessel to a destination. In one embodiment, the route setting unit may be a part of the vessel controller 330.

In one embodiment, the autonomous control system of vessel 300 may further comprise peripheral sensors (not shown) and these peripheral sensors may be referred as external recognition sensors for recognizing the external environment and may comprise but not limit thereto camera, lidar, radar, sonar, ultrasonic sensor, etc. The peripheral sensors may be used to detect the existence of another vessel 400. Alternatively, the peripheral sensors may be used to detect a distance between the vessel 300 and the another vessel 400.

The GNSS receiving antenna 310 is used to receive the GNSS signals. The GNSS (global navigation satellite system) is a system that uses satellites to provide autonomous geo-spatial positioning. The GNSS allows satellite navigation device in the vessel 300 to determine the position (longitude, latitude, and altitude/elevation) with high precision using time signals transmitted along a line of sight by radio from satellites. The system can be used for providing position, navigation or for tracking the position of something fitted with a receiver (satellite tracking). With the GNSS receiving antenna 310, signals from the satellite may be received and the position of the vessel 300 may be determined.

The wind direction and wind speed receiving antenna 320 is used to receive data of the wind direction and the wind speed from the anemometer 200 and/or the other vessels. The vessel 300 may constantly receive the disturbance data related to the wind direction and wind speed by the wind direction and wind speed receiving antenna 310.

In addition, a human machine interface (HMI) 335 is also included in the autonomous control system of vessel 300. The HMI 335 may refer as an input interface and be connected to the vessel controller 330. The user, such as the driver of the vessel 300, can input parameters, select control modes, etc., through the HMI 335. For example, the user can select an automatic berthing mode through the HMI 335. Once the vessel controller 330 receives the automatic berthing mode input by the user, the vessel controller 330 starts perfume an automatic berthing control for the vessel 300. In one embodiment, the HMI 335 may be implemented by keyboard, mouse, touch panel or the like.

In addition to the automatic berthing mode, there are various modes for controlling the vessels, so as to carry out the autonomous controls of the vessel 300.

The vessel controller 330 may be implemented by a processor, such as a central processing unit of a computer or the like. The vessel controller 330 may refer to a kind of an autonomous control unit. The vessel controller 330 can control all components of the vessel 300. For example, when the vessel controller 330 performs the automatic berthing control, the vessel 300 will be automatically guided to a pier, quay, or similar fixture, or be automatically guided to an allotted space at the pier, quay, or similar fixture. The automatic berthing control can be made through the vessel controller 330 performing controls of the outboard motors 340a, 340b.

In another embodiment, the autonomous control system of vessel 300 may further comprise another receiving unit that can receive data from the aerial drone and/or the underwater drone to obtain the disturbance data. The aerial drone and/or the underwater drone may communicate with the autonomous control system of vessel 300. For example, the aerial drone may provide the wind direction and the wind speed at a location where the aerial drone hovers or at locations along a path that the aerial drone flies. In addition, the underwater drone can provide the disturbance data related to the tide or wave under the sea.

In another embodiment, the autonomous control system of vessel 300 may further comprise another receiving unit that can receive image data from the satellite. For example, the image data may be image of waves on the sea at different times. When autonomous control system of vessel 300 receives the image data from the satellite, the autonomous control system can analyze the received image data to obtain the amplitude, the speed, and the direction of the wave as the disturbance data. The component for analyzing the image data from the satellite may be separated form or provided in the vessel controller 330.

In addition, although not shown in FIG. 3, the autonomous control system of vessel 300 may further comprise a wireless communication unit or interface that is able to communicate with the anemometer 200 and the other vessels 400, such as data or command transmission and reception. The autonomous control system of vessel 300 may communicate with the plural anemometers 200 and other vessel 400 by means of wireless communication through the wireless communication unit.

The GNSS receiving antenna 310, the wind direction and speed receiving antenna 320 and other peripheral sensors may be referred to a disturbance data acquisition unit that acquires the disturbance data from sources (such as the anemometer 200 on the pier) other than the vessel.

In FIG. 3, the autonomous control system of vessel 400 basically has the similar configuration of the autonomous control system of vessel 300. In general, the autonomous control system of vessel 400 also comprises a GNSS receiving antenna 410, a wind direction and speed receiving antenna 420, a vessel controller (autonomous control unit) 330, a route setting unit, peripheral sensors and other components (not shown) for operations of the vessel 400. The route setting unit is also configured to set a route of the vessel to a destination. In one embodiment, the route setting unit may be a part of the vessel controller 430.

In addition, the autonomous control system of vessel 400 also comprises a vessel controller (autonomous control unit) 430, an HMI 435, outboard motor 440a, 440b. The autonomous control system of vessel 400 may further comprise a wireless communication unit or interface that is able to communicate with the anemometer 200 and the own vessel 300, such as data or command transmission and reception. These components perform the same or similar functions as the autonomous control system of vessel 300, and thus their detail descriptions are omitted.

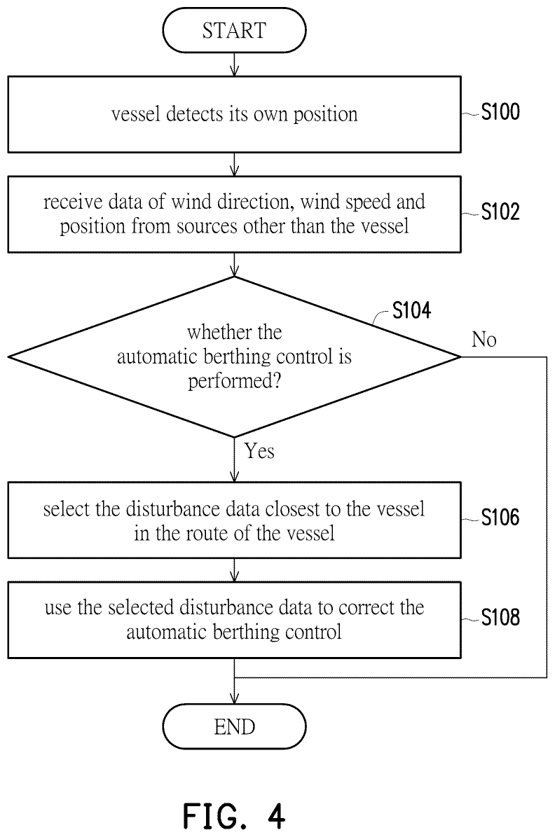

The operation of the autonomous control system in FIG. 3 will be described with reference to FIG. 4. FIG. 4 illustrates a flow chart of an autonomous control method according to one embodiment of the disclosure.

Referring to FIGS. 3 and 4, first, a route of the vessel 300 may be set so that the vessel 300 may move to a destination (such as the berthing position) by the route setting unit that is independent from the vessel controller (autonomous control unit) 330 or incorporated therein. In the example, the automatic berthing control is used as an example of the autonomous control and the route may be an automatic berthing route.

Referring to FIGS. 1 to 4, in at step S100, the vessel 300 detects the own position. For example, the GNSS receiving antenna 310 may be used to receive the satellite signals and thus the own position of the vessel 300 may be acquired.

Next, at step S102, the disturbance data, which includes the wind direction, the wind speed and positon of sources (such as the anemometer 200) other than the vessel are received. For example, the wind direction and speed receiving antenna 320 of the vessel 300 may be used to receive the disturbance information of the wind direction and the wind speed from the anemometer 200 or from the other vessels 400. In addition, the data acquisition position information (or simply position information) of the anemometer 200 and the other vessels 400 may be also received.

In addition, a time out may be set for the acquired disturbance data. In this manner, the old disturbance data may be discarded. Thus, only the latest disturbance data is stored and thus the precision of the vessel control may be increased.

Next, during the autonomous control, at Step 104, whether the automatic berthing control is performed is determined. If the automatic berthing control is not performed, the autonomous control is stopped.

In contrast, at Step 106, when the automatic berthing control is performed, the vessel controller 330 may select the disturbance data that is closest to the vessel 300 in the route of the vessel 300. According to the position information obtained at Step 102, when the is performed, the disturbance data that is closest to the vessel 300 may be used. By using the disturbance data closest to the vessel 300, the control precision may be increased. The disturbance data closest to the vessel 200 may be within a predetermined distance from the route of the vessel 200.

Next, at step 108, the selected disturbance data is used to correct the automatic berthing control. For example, when a drafting direction of the vessel 300 due to disturbance is specified, the vessel 300 is applied by a propulsion in a direction opposite to the drafting direction to keep the vessel 300 move along the route. In another embodiment, the automatic berthing control may be temporally stopped when the disturbance data is equal to or larger than a predetermined value.

As described above, in the embodiment, by installing an anemometer at the berthing position (such as the pier or trailer located at the shore), the wind direction and the wind speed at various positions other than the own vessel may be received by the own vessel. In addition, the disturbance data closest to the route of the vessel may be used to correct the vessel control, and thus the precision of the vessel control may be increased.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An autonomous control system for a vessel, comprising:
a route setting unit, setting a route to a destination;
a disturbance data acquisition unit, acquiring disturbance data from sources other than the vessel;
an autonomous control unit, performing a control of the vessel based on the route set by the route setting unit and corrects the control of the vessel based on the disturbance data acquired by the disturbance data acquisition unit.

2. The autonomous control system according to claim 1, wherein the disturbance data comprises disturbance information and data acquisition position information, and the autonomous control unit is further configured to correct the control of the vessel based on the disturbance data within a predetermined distance from the route.

3. The autonomous control system according to claim 1, wherein the disturbance data comprises at least one of a wind speed and direction and tide information.

4. The autonomous control system according to claim 1, wherein the sources comprise at least one of other vessels, anemometers arranged on a marina, an anemometer arranged on a trailer at a shore.

5. The autonomous control system according to claim 1, wherein the disturbance data is obtained from at least one of an aerial drone and an underwater drone capable of communicating with the vessel.

6. The autonomous control system according to claim 1, wherein the disturbance data is obtained from satellite images.

7. The autonomous control system according to claim 1, wherein when a drafting direction of the vessel due to disturbance is specified, the vessel is applied by a propulsion in a direction opposite to the drafting direction to keep the vessel move along the route.

8. The autonomous control system according to claim 1, wherein the disturbance data has plural types.

9. The autonomous control system according to claim 1, wherein the autonomous control unit has an automatic berthing mode, and an automatic berthing control is temporally stopped when the disturbance data is equal to or larger than a predetermined value.

10. The autonomous control system according to claim 9, wherein the automatic berthing control is in operation, the disturbance data is received from other vessels and disturbance data collection devices arranged on a marina or trailers.

11. An autonomous control method for a vessel, comprising:
setting a route to a destination;
acquiring disturbance data from sources other than the vessel; and
performing a control of the vessel based on the set route set and corrects the control of the vessel based on the acquired disturbance data.

12. The autonomous control method according to claim 11, wherein the disturbance data comprises disturbance information and data acquisition position information, and the method further comprises:
correcting the control of the vessel based on the disturbance data within a predetermined distance from the route.

13. The autonomous control method according to claim 11, wherein the disturbance data comprises at least one of a wind speed and direction and tide information.

14. The autonomous control method according to claim 11, wherein the sources comprise at least one of other vessels, anemometers arranged on a marina, an anemometer arranged on a trailer at a shore.

15. The autonomous control method according to claim 11, further comprising:
obtaining the disturbance data from at least one of an aerial drone and an underwater drone capable of communicating with the vessel.

16. The autonomous control method according to claim 11, further comprising:
obtaining the disturbance data from satellite images.

17. The autonomous control method according to claim 11, further comprising:
specifying a drafting direction of the vessel due to disturbance; and
applying a propulsion to the vessel in a direction opposite to the drafting direction to keep the vessel move along the route.

18. The autonomous control method according to claim 11, wherein the disturbance data has plural types.

19. The autonomous control method according to claim 11, wherein in a case that an automatic berthing mode is performed, the method further comprises:
temporally stopping an automatic berthing control when the disturbance data is equal to or larger than a predetermined value.

20. The autonomous control method according to claim 19, wherein the automatic berthing control is in operation, and the method further comprises:
receiving the disturbance data from other vessels and disturbance information collection devices arranged on a marina or trailers.
